(19) United States
(12) Patent Application Publication
(10) Pub. No.: US 2005/0280689 A1
(43) Pub. Date: Dec. 22, 2005

(54) Flat bed thermal processor employing heated rollers

(76) Inventors: Duane A. Preszler, River Falls, WI (US); Brian L. Johnson, Woodbury, MN (US)

Correspondence Address: Pamela R. Crocker;Patent Legal Staftf, Eastman Kodak Company, 343 State Street, Rochester, NY, 14650-2201, US

(21) Appl. No.: 10/873,816

(22) Filed: Jun. 22, 2004

(51) Int. Cl. B41J 2/315

(52) U.S. Cl. 347/171; 347/61

(57) ABSTRACT

A thermal processor for thermally developing an image in an imaging material. The thermal processor includes an oven and a plurality of rotatable members. The plurality of rotatable members are positioned to form a transport path, and through contact with the imaging material, are configured to move the imaging material through the oven along the transport path. At least one of the rotatable members includes an internal heater such that the at least one rotatable member heats the imaging material as the imaging material moves along the transport path. An internal heater is controllable to provide an amount of thermal energy based on processing parameters associated with the imaging material.

### FIELD OF THE INVENTION

The present invention relates generally to an apparatus and method for processing an imaging material, and more specifically an apparatus and method for thermally developing an imaging material employing heating of rotatable members which form a transport path.

### BACKGROUND OF THE INVENTION

Photothermographic film generally includes a base material coated on at least one side with an emulsion of heat sensitive materials. Once the film has been subjected to photo-stimulation by optical means (e.g., laser light), or “imaged”, the resulting latent image is developed through the application of heat to the film. In general, the uniformity in the density of a developed image is affected by the manner in which heat is transferred to the emulsion of heat sensitive material. Non-uniform heating can result in uneven density of the developed image. Uneven contact between the film and any supporting structures during the development process can also produce visible marks, patterns, and other visual artifacts on the developed image. Therefore, the uniform transfer of heat to the heat sensitive materials is critical in producing a high quality image.

Several types of processing machines have been developed in efforts to achieve optimal heat transfer to sheets of photothermographic film during processing. One type of processor, commonly referred to as a “flat bed” processor, typically comprises an oven enclosure within which a number of spaced rollers are configured so as to form a generally horizontal transport path through the oven, wherein some type of heat source is positioned along and in proximity to the transport path. In one configuration, a plurality of upper rollers and a plurality of lower rollers are staggered in a horizontal direction and slightly overlap a horizontal plane in a vertical direction to form a slightly sinusoidal, or corrugated, transport path through the oven. A drive system is employed to cause the rollers to rotate and move a piece of film through the oven along the transport path from an oven entrance to an oven exit. As the film moves along the transport path, the heat source heats the film to a temperature necessary to develop the image.

While flat bed type processors are effective at developing photothermographic film, variations in image density and can result from temperature variations between the rollers. Prior to any photothermographic film entering the oven, the rollers, along with other internal surfaces of the oven, are heated by the heat source to a desired temperature. As a piece of photothermographic film enters the oven and contacts the rollers, heat is transferred to the photothermographic film from both the heat source and from contact with the surfaces of the rollers. However, as heat is transferred from the rollers to the photothermographic film, the surfaces of the rollers can drop below the desired temperature and, consequently, begin to transfer less heat to the imaging material. This is particularly true of rollers that form an initial portion of the transport path.

As a result, a leading portion of a piece of photothermographic film may receive more heat than a trailing portion of the piece of photothermographic film. Likewise, later pieces of photothermographic film may receive less thermal energy from the rollers than earlier pieces of photothermographic film transported through the oven. As a result, heat is not uniformly transferred to the photothermographic film and, consequently, image density may vary between consecutively developed pieces of photothermographic film and even within a single piece of photothermographic film.

It is evident that there is a continuing need for improved photothermographic film developers. In particular, there is a need for a thermal processor that substantially reduces variations in image density resulting from variations in roller temperatures as described above.

### SUMMARY OF THE INVENTION

In one embodiment, the present invention provides a thermal processor for thermally developing an image in an imaging material. The thermal processor includes an oven and a plurality of rotatable members. The plurality of rotatable members are positioned to form a transport path, and through contact with the imaging material, are configured to move the imaging material through the oven along the transport path. At least one of the rotatable members includes an internal heater such that the at least one rotatable member heats the imaging material as the imaging material moves along the transport path. The internal heater is controllable to provide an amount of thermal energy based on processing parameters associated with the imaging material.

By providing thermal energy to the rotatable members, the rotatable members are better able to maintain a consistent temperature as is thermal energy is transferred from the rotatable members to the imaging material as the imaging material moves through oven along the transport path. As a result, temperature variations between the rotatable members is reduced, which substantially reduces variations in image density caused by non-uniform heat transfer to the imaging material. Additionally, by heating the rotatable members, thermal energy transferred from the rotatable members to the imaging material can replenished more quickly, which can increase the throughput of the thermal processor.

These objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 is a side sectional view of one exemplary embodiment of a thermal processor according to the present invention.

FIG. 2 is a block diagram illustrating one exemplary embodiment of the thermal processor shown in FIG. 1.

FIG. 3 is a graph illustrating a temperature of a piece of imaging material during processing by the thermal processor of FIG. 1.

FIG. 4 is a graph illustrating an exemplary thermal energy relationship between a heated roller and imaging material.

FIG. 5A is a length-wise sectional view of one exemplary embodiment of a heated roller according to the present invention.

FIG. 5B is a cross-sectional view of the exemplary embodiment the heated roller shown in FIG. 5A.

FIG. 6 is a side sectional view of another embodiment of a thermal processor according to the present invention.

### DETAILED DESCRIPTION OF THE INVENTION

The following is a detailed description of the preferred embodiments of the invention, reference being made to the drawings in which the same reference numerals identify the same elements of structure in each of the several figures.

Reference is made to U.S. patent application Ser. No. 10/815,027 entitled “Apparatus and Method For Thermally Processing An Imaging Material Employing a Preheat Chamber,” filed on Mar. 31, 2004, assigned to the same assignee as the present application, and herein incorporated by reference.

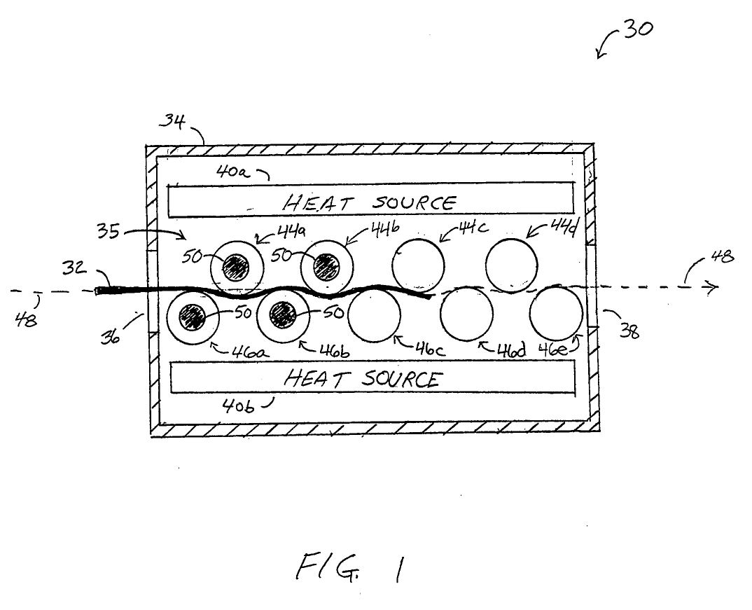

FIG. 1 is a cross-sectional view illustrating one exemplary embodiment of a thermal processor 30 employing heated rollers in accordance with the present invention for developing an image in an imaging material 32. Thermal processor 30 includes an enclosure 34 that forms an oven 35 having an entrance 36 and an exit 38. An oven heater 40, illustrated as an upper heat source 40a and a lower heat source 40b, is configured to maintain oven 35 substantially at a desired temperature.

A plurality of upper rollers 44 and a plurality of lower rollers 46 are rotatably mounted to opposite sides of enclosure 34 and positioned in a spaced relationship so as contact imaging material 32 and to form a transport path 48 through oven 35. One or more of the rollers 44 and 46 can be driven such that contact between rollers 44 and 46 and imaging material 32 moves imaging material 32 through oven 35 along transport path 48 from entrance 36 to exit 38. A portion of upper rollers 44, illustrated as rollers 44a and 44b, and a portion of lower rollers 46, illustrated as rollers 46a and 46b, include an internal heater 50, wherein each internal heater 50 provides thermal energy based on processing parameters associated with imaging material 32. Processing parameters associated with imaging material 32 can include data indicative of the type, dimensions, and age of imaging material 32, as well as data indicative of the speed at which imaging material 32 will be transported through oven 35.

Imaging material 32 enters oven 35 at entrance 36 at an ambient temperature. As imaging material 32 moves along transport path 48, imaging material 32 is initially heated by upper and lower heat sources 40a and 40b and by heated rollers 44a, 44b, 46a, and 46b. Based on the processing parameters, heated rollers 44a, 44b, 46a, and 46b provide an amount of thermal energy that, together with thermal energy provided by upper and lower heat sources 40a and 40b, causes imaging material 32 to be heated to substantially the desired temperature after contact with the final heated roller. As illustrated, the final heated roller is upper roller 44b. The remaining non-heated rollers, 44c, 44b, 46c, 46d, and 46c, then move imaging material 32 the remaining distance along transport path 48 to exit 38, wherein both imaging material 32 and non-heated rollers 44c, 44b, 46c, 46d, and 46c, are maintained as substantially the desired temperature by upper and lower heat sources 40a and 40b.

In one embodiment, as illustrated, upper rollers 44 are horizontally offset from lower rollers 46 and are vertically positioned such that upper rollers 44 and lower rollers 46 overlap a horizontal plane such that transport path 48 is undulating, or sinusoidal in shape. Positioning the upper rollers 44 and lower rollers 46 in this fashion causes imaging material 32 to be bent or curved as it moves along transport path 48. Curving imaging material 32 in this fashion increases a column stiffness of imaging material 32 and enables imaging material 32 to be heated and transported through oven 35 without a need for nip rollers or other pressure transporting means.

By providing thermal energy to rollers 44 and 46 via internal heaters 50, rollers 44 and 46 of thermal processor 30 are better able to maintain a consistent temperature as is transferred to imaging material 32 as imaging material 32 moves through oven 35 along transport path 48. As a result, thermal processor 30 substantially reduces temperature variations between rollers 44 and 46, thereby substantially reduces variations in image density caused by non-uniform heat transfer to imaging material 32. Furthermore, by internally heating rollers 44 and 46, thermal energy transferred from rollers 44 and 44 to imaging material 32 can be replenished more quickly than with oven heater 40 alone. As a result, the throughput (i.e., the amount of imaging material processed in a give time) of thermal processor 30 can be increased.

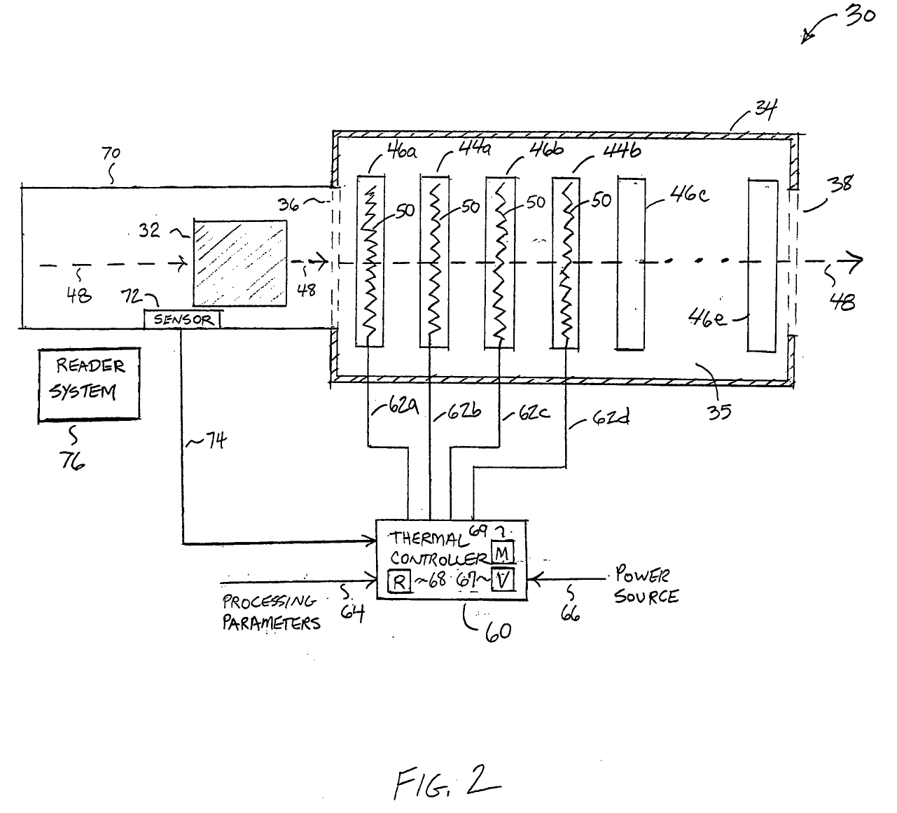

FIG. 2 is a block diagram illustrating generally one embodiment of thermal processor 30 according to the present invention further including a thermal controller 60 for individually controlling the amount of thermal energy provided by each internal resistive heater 50. FIG. 2 is generally representative of a top view of thermal processor 30 with spacing between rollers 44 and 46 exaggerated for ease of illustration. Thermal controller 60 is coupled to each internal heater 50 via an electrical path 62, receives processing parameters associated with imaging material 32 via a path 64, and receives electrical power via a path 66. In one embodiment, internal heaters 50 are substantially identical electrical resistive heaters, each having a substantially equal maximum power rating (e.g., a maximum number of watts per unit length).

As described above in regard to FIG. 1, imaging material 32 enters oven 35 at entrance 36 at an ambient temperature and is heated by both oven heater 40 and heated rollers 44 and 46 as it moves along transport path 48. As such, the temperature difference between imaging material 32 and rollers 44 and 46 (the “ΔT”) decreases as imaging material 32 moves along transport path 48, with the ΔT between imaging material 32 and lower roller 46a being greater than the ΔT between imaging material 32 and lower roller 46c. Due to the differing temperature differentials, the amount of thermal energy transferred to imaging material 32 by rollers 44 and 46 decreases as imaging material 32 moves from lower roller 46a to lower roller 46c.

In one embodiment, based on the varying heat transfer characteristics among rollers 44 and 46 and on the processing parameters associated with imaging material 32, thermal controller 60 individually controls the power provided to internal heaters 50 of rollers 44 and 46 via paths 62 to thereby individually control the thermal energy provided to rollers 44 and 46. In one embodiment, thermal controller 60 provides an amount of thermal energy to the associated internal heater 50 of each roller 44 and 46 that is substantially equal to an amount of thermal energy expected to be transferred to imaging material 32 by each roller 44 and 46 as imaging material 32 moves along transport path 48. In one embodiment, thermal controller 60 provides an amount of thermal energy to the associated internal heater of each roller 44 and 46, such that the amount of thermal energy transferred to imaging material 32 by rollers 44 and 46 and by oven heater 40 is such that the ΔT between imaging material 32 and the rollers following roller 44b (i.e. 46c to 46e) is substantially equal to zero.

In one embodiment, thermal controller 60 individually controls the thermal energy provided to each roller 44 and 46 by controlling the current provided to internal heater 50 associated with each roller. In one embodiment, thermal controller 60 separately controls both a magnitude and duration of a current applied to each internal heater 50.

In one embodiment, thermal controller 60 includes a voltage regulator 67 that maintains a voltage level provided to internal heaters 50 via paths 62 at a substantially constant level regardless of fluctuations that may occur in the level of a power source voltage received via path 66. In one embodiment, thermal controller 60 includes a resistance compensator 68 configured to compensate for differences in resistive values of internal heaters 50 when determining an amount of current to be provided to each internal heater 50. In one embodiment, thermal controller 60 cross references the processing parameters with a look-up table stored in a memory 69 to determine an amount of current to provide to each of the internal heaters 50.

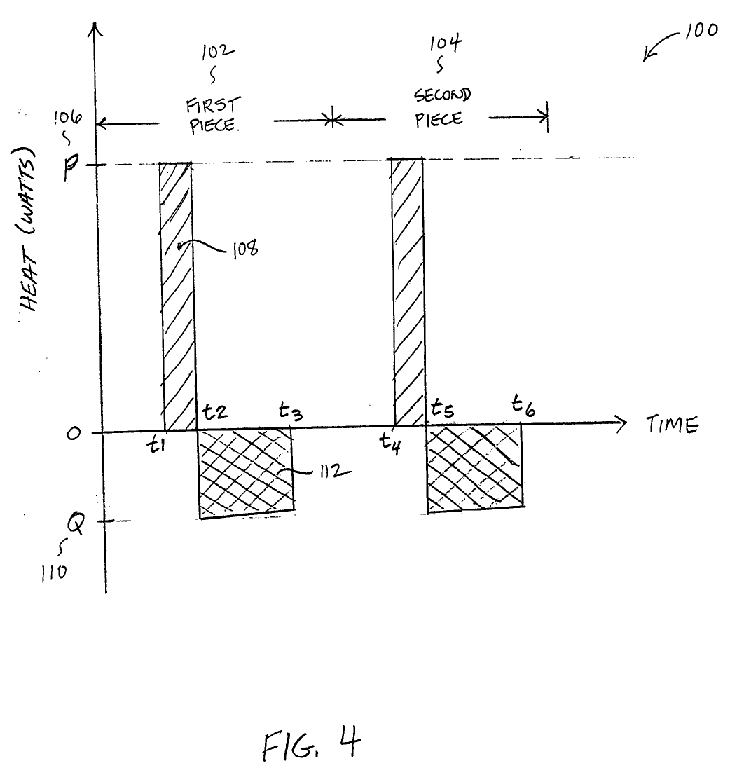

In one embodiment, thermal processor 30 includes a feeder section 70 into which imaging material 32 is loaded by a user. In one embodiment, as imaging material 32 is fed toward entrance 36 to oven 35, a sensor 72 provides indication to thermal controller 60 via a path 74 of when imaging material 32 passes a point on transport path 48 that is a known distance from the first heated roller, as illustrated roller 46a. Based on the speed that imaging material 32 is moving, which can be included as one of the processing parameters received via path 64, thermal controller 60, in one embodiment, provides a predetermined amount of thermal energy to each roller 44 and 46 via its associated internal heater 50 before each roller 44 and 46 contacts imaging material 32. This is described in great detail below by FIG. 4.

In one embodiment, thermal processor 30 includes a reader system 76 configured to read the processing parameters associated with imaging material 32 from packaging in which imaging material is stored or from the imaging material itself, and to provide the processing parameters to thermal controller 60. In one embodiment, reader system 76 includes a bar code scanner to read processing parameters affixed to either the imaging material or imaging material packaging in the form of a bar code. In one embodiment, reader system includes a radio frequency (RF) transmitter/receiver configured to read processing parameters affixed to either the imaging material or imaging material packaging in the form of an RF tag device.

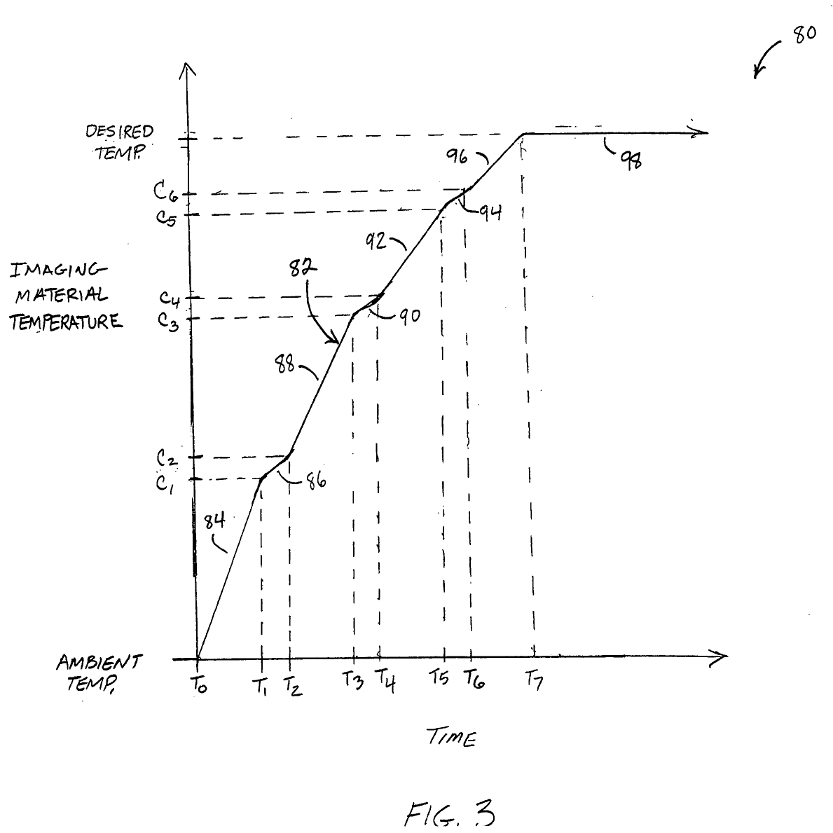

FIG. 3 is a graph 80 of a waveform 82 illustrating the temperature level of imaging material 32 as it travels through thermal processor 30 as illustrated by FIG. 1. The temperature of imaging material 32 is illustrated along the y-axis and time is illustrated along the x-axis. Graph 80 illustrates segments of waveform 82 which correspond to positions along transport path 48 at which imaging material 32 is located during a given time period.

Segment 84 illustrates the temperature of imaging material 32 while it is in contact with roller 46a during a time period from T0 and T1, during which time the temperature of imaging material 32 rises from an ambient temperature to a temperature C1. Segment 86 corresponds to imaging material 32 being between rollers 46a and 44a during a time period from T1 to T2, during which time the temperature of imaging material 32 rises from temperature C1 to a temperature of C2. Segment 88 illustrates the temperature of imaging material 32 while it is in contact with roller 44a during a time period from T2 and T3, during which time the temperature of imaging material 32 rises from temperature C2 to a temperature C3.

Segment 90 corresponds to imaging material 32 being between rollers 44a and 46b during a time period from T3 to T4, during which time the temperature of imaging material 32 rises from temperature C3 to a temperature C4. Segment 92 illustrates the temperature of imaging material 32 while it is in contact with roller 46b during a time period from T4 and T5, during which time the temperature of imaging material 32 rises from temperature C4 to a temperature C5. Segment 94 corresponds to imaging material 32 being between rollers 46b and 44b during a time period from T5 to T6, during which time the temperature of imaging material 32 rises from temperature C5 to a temperature C6.

Segment 96 illustrates the temperature of imaging material 32 while it is in contact with roller 44b during a time period from T6 and T7, during which time the temperature of imaging material 32 rises from temperature C6 to a desired temperature. Segment 98 illustrates the temperature of imaging material 32 as it moves along transport path 48 beyond heater roller 44b, wherein imaging material 32 is maintained at the desired operating temperature by oven heater 40.

As illustrated by graph 80, the amount of the temperature increase of imaging material 32 due to contact with the heated rollers (i.e., 44a, 44b, 46a, and 46b), and thus the amount of thermal energy transferred to imaging material 32 by the rollers, decreases as imaging 32 moves through oven 35. As illustrated by graph 80, and as described above, the largest temperature increase of imaging material 32 due to roller contact occurs from contact with the first heated roller 46a and the smallest temperature increase occurs from contact with the final heater roller 44b.

FIG. 4 is a graph 100 illustrating the provision of thermal energy to a given roller, such as roller 46a, via its associated internal heater 50 by thermal controller 60 and the transfer of thermal energy from roller 46a to imaging material 32 as it moves along transport path 48. As indicated at 102 and 104, graph 100 illustrates this relationship for two pieces of imaging material 32.

In response to a position indication received from sensor 72 and to processing parameters associated with the first piece of imaging material 32, such as provided by reader system 76, thermal controller 60 determines, such as from the look-up table in memory 69, an amount of electrical current to provide to internal heater 50 of roller 46a and for what duration. The magnitude of electrical current and the duration it is applied to internal heater 50 determines the amount of thermal energy internal heater 50 provides to roller 56a, and is such that the amount of thermal energy provided by internal heater 50 to roller 46a is substantially equal to the amount of thermal energy expected to be absorbed from roller 46a by imaging material 32 while in contact with roller 46a.

For the example illustrated by FIG. 4, thermal controller 60 provides a selected amount of current that causes internal heater 50 to generate “P” Watts of power, as indicated at 106. Thermal controller 60 applies the selected current to thermal heater 50 for the time period from t1 to t2, which results in internal heater 50 providing an amount of thermal energy to roller 46a that is represented by the hatched area 108. At time t2, which is the time that imaging material 32 is expected to contact roller 46a as based on the position indication received from sensor 72 and the imaging material speed from the associated operating parameters, thermal controller 60 ceases providing electrical current to internal heater 50.

At time t2, imaging material 32 contacts and begins absorbing from roller 46a, Q watts of power as indicated at 110. Imaging material 32 is in contact with roller 46a from time t2 to time t3, during which time it absorbs an amount of thermal energy from roller 46a that is represented by the cross-hatched area 112. The hatched area 108 is substantially equal to the cross-hatched area 112, which represents that the amount of thermal energy provided to roller 46a by its associated internal heater 50 is substantially equal to the amount of thermal energy absorbed from roller 46a by imaging material 32 as it moves along transport path 48.

The above described process is repeated for the second piece of imaging material 32, and for each subsequent piece of imaging material 32 that is to be developed by thermal processor 30. While, as illustrated, the second piece 104 of imaging material 32 has substantially equal processing characteristics relative to the first piece 102 of imaging material 32, each consecutive piece of imaging material 32 can have different thermal requirements. As a result, thermal controller 60 may provide a different amount of current for a different duration to internal heater 50 of roller 46a for each consecutive piece of imaging material 32 processed by thermal processor 30. Furthermore, while graph 100 indicates the cessation of the provision of thermal energy to a given roller as coinciding with its contacting the imaging material (as indicated at times t2 and t5), the provision of thermal energy to a roller can be discontinue prior to contact with the imaging material or can continue to be provided to a roller after it contacts the imaging material, depending on thermal requirements of the imaging material.

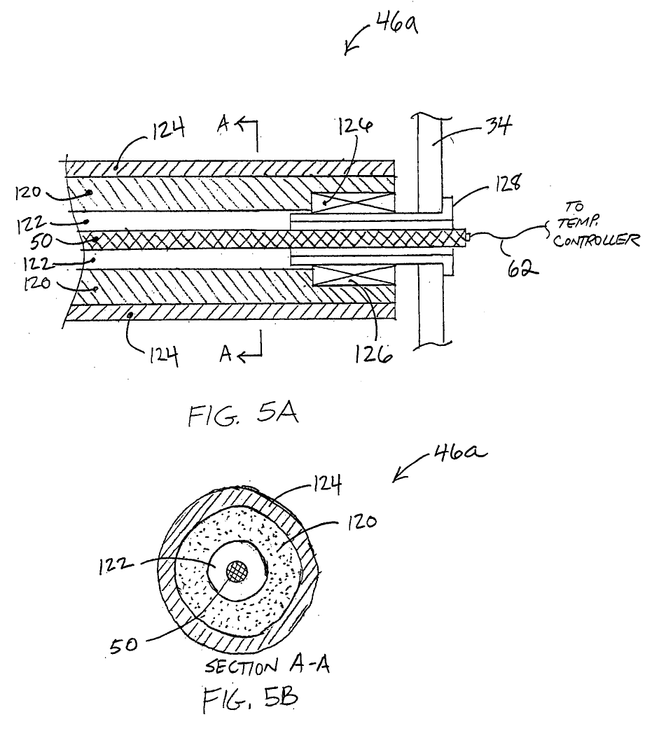

FIGS. 5A and 5B are schematic diagrams respectively illustrating a lateral cross-sectional view and a cross-sectional view of one exemplary embodiment of a heated roller, such as heated roller 46a, as employed by thermal processor 30. Roller 46a includes a support shaft 120 having a hollow interior 122. In one embodiment, support shaft 120 is constructed of aluminum. In one embodiment, as illustrated, roller 46a includes a sleeve of support material 124 surrounding the external surface of support 120.

In one embodiment, as illustrated, roller 46a includes a bearing 126, or other low-friction device, which is configured to slidably fit over a support shaft 128 such that roller 46a is free to rotate around the stub shaft 128. As illustrated, stub shaft 128 is hollow and is mounted to and extends through a side of enclosure 34 such that stationary internal heater 50 can be inserted into the hollow interior 122 of roller 46a. In other embodiments, internal heater 50 can rotate with roller 46a.

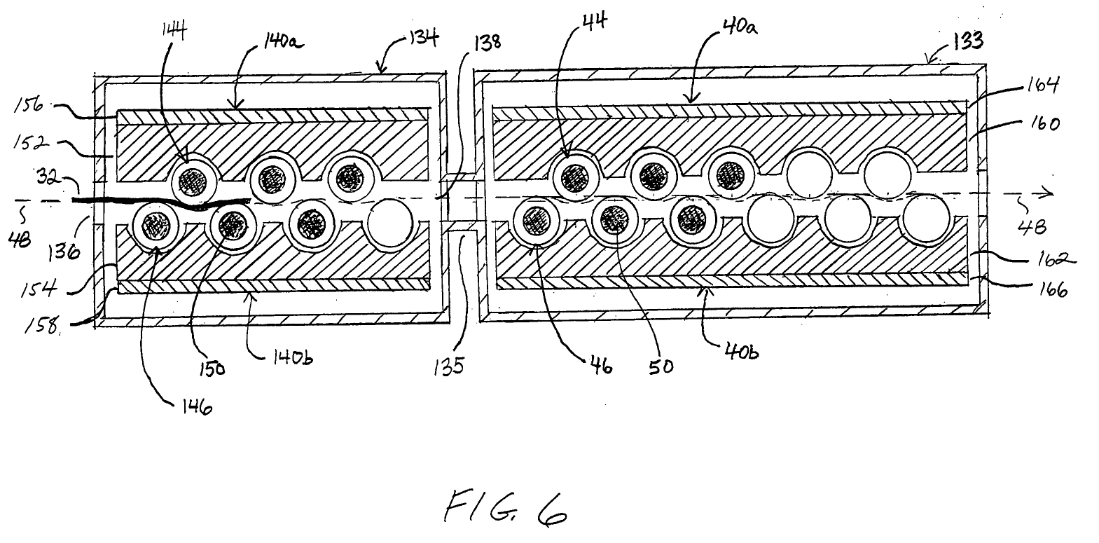

FIG. 6 is a side sectional view illustrating another exemplary embodiment of thermal processor 30 in accordance with the present invention further including an enclosure 134 configured as a preheat chamber, and wherein enclosure 34 is configured as a dwell chamber 133. Thermal processor 30 is configured such that preheat chamber 134 heats imaging material 32 to a first temperature and dwell chamber 133 heats imaging material 32 to a second temperature, wherein the first temperature is less than the second temperature. In one embodiment, as illustrated, preheat chamber 134 is thermally isolated from and coupled to dwell chamber 133 via a transition section 135. In one embodiment, the first temperature comprises a conditioning temperature and the second temperature comprises a developing temperature associated with the imaging material. A thermal processor having a similar configuration is described by the described by the previously incorporated U.S. patent application Ser. No. 10/815,027 entitled “Apparatus and Method For Thermally Processing an Imaging Material Employing a Preheat Chamber.”

Preheat chamber 134 has an entrance 136 and an exit 138, and includes upper and lower heat sources, 140a and 140b, and a plurality of upper and lower rollers, 144 and 146. A portion of upper rollers 144 and lower rollers 146 include an internal heater 150, wherein each internal heater 150 provides thermal energy based on the processing parameters associated with imaging material 32. In a fashion similar to that of dwell chamber 133, the plurality of upper rollers 144 and lower rollers 146 are rotatably mounted to opposite sides of preheat chamber 134 and positioned in a spaced relationship so as to contact imaging material 32 and to form a transport path through preheat chamber 134 from entrance 136 to exit 138. One or more of the rollers 144 and 146 can be driven such that contact with between rollers 144 and 146 and imaging material 32 moves imaging material 32 through preheat chamber 134. In one embodiment, as illustrated, upper rollers 144 are horizontally offset from lower rollers 146 and are vertically positioned such that upper rollers 144 and lower rollers 146 overlap a horizontal plane such that transport path through preheat chamber 134 is undulating, or sinusoidal in shape.

Upper and lower heat sources 140a and 140b of preheat chamber 134 respectively include heat plates 152 and 154 and blanket heaters 156 and 158. Upper and lower heat sources 40a and 40b of dwell chamber 133 respectively include heat plates 160 and 162 and blanket heaters 164 and 166. Blanket heaters 156, 158, 164, and 166, and heat plates 152, 154, 160, and 162 can be configured with multiple zones, with the temperature of each zone being individually controlled. In one embodiment, as illustrated, heat plates 152, 154, 160, and 162 are shaped so as to partially wrap around a portion of the circumference of rollers 44, 46, 144, and 146 such that the rollers are “nested” within their associated heat plate. By nesting rollers 44, 46, 144, and 146 within heat plates 152, 154, 160, and 162 in this fashion, the temperature of the rollers can be more evenly maintained.

As imaging material 32 moves through preheat chamber 134, upper and lower heat sources, 140a and 140b, and heated rollers, 144 and 146, heat imaging material 32 from an ambient temperature to substantially the first temperature. As imaging material 32 moves through dwell chamber 133, upper and lower heat sources, 40a and 40b, and heated rollers, 44 and 46, heat imaging material 32 from substantially the first temperature to substantially the second temperature. While imaging material 32 contacts non-heated rollers of preheat chamber 134 and dwell chamber 133, upper and lower heat sources 140a/140b and 40a/40b respectively maintain imaging material 32 substantially at the first temperature and substantially at the second temperature.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

Parts List

30 Thermal Processor
32 Imaging Material
34 Enclosure
35 Oven
36 Oven Entrance
38 Oven Exit
40 Heat Source
44 Upper Rollers
46 Lower Rollers
48 Transport Path
50 Internal Heater
60 Thermal Controller
62 Electrical Path
67 Voltage Regulator
68 Resistance Compensator
69 Memory
70 Feeder Section
72 Location Sensor
76 Reader System
120 Roller Support Shaft
122 Roller Hollow Interior
124 Support Material
126 Bearing
128 Stub Shaft
133 Dwell Chamber
134 Preheat Chamber
135 Transition Section
136 Preheat Chamber Entrance
138 Preheat Chamber Exit
140 Preheat Chamber Heat Source
144 Preheat Chamber Upper Rollers
146 Preheat Chamber Lower Rollers
152 Heat Plate
154 Heat Plate
156 Blanket Heater
158 Blanket Heater
160 Heat Plate
162 Heat Plate
164 Blanket Heater
166 Blanket Heater

1. A thermal processor for thermally developing an image in an imaging material, the thermal processor comprising:
an oven; and
a plurality of rotatable members positioned to form a transport path and, through contact with the imaging material, configured to move the imaging material through the oven along the transport path, wherein at least one of the rotatable members includes an internal heater such that the at least one rotatable member heats the imaging material as the imaging material moves along the transport path, and wherein the internal heater is controllable to provide an amount of thermal energy based on processing parameters associated with the imaging material.

2. The thermal processor of claim 1, wherein the internal heater is controllable so as to provide an amount of thermal energy substantially equal to an expected amount of thermal energy expected to be absorbed by the imaging material while the imaging material is in contact with the at least one rotatable member as the imaging material moves through the oven along the transport path, wherein the expected amount of thermal energy is based on the processing parameters associated with the imaging material.

3. The thermal processor of claim 1, wherein a plurality of the rotatable members include an internal heater, wherein each internal heater is individually controllable to provide an amount of thermal energy based on the processing parameters associated with the imaging material.

4. The thermal processor of claim 1, wherein the internal heater is stationary relative to the oven.

5. The thermal processor of claim 1, wherein the internal heater is an electrical resistive heater

6. The thermal processor of claim 1, further including a thermal controller configured to receive the processing parameters associated with the imaging material and to control the amount of thermal energy provided by the internal heater based on the processing parameters.

7. The thermal processor of claim 6, wherein the thermal controller receives the processing parameters from the imaging material and/or from packaging associated with the imaging material.

8. The thermal processor of claim 6, wherein the thermal controller cross references the processing parameters to a look-up table stored in a memory to determine an amount of thermal energy to be provided by the internal heater.

9. The thermal processor of claim 6, wherein the internal heater is an electrical resistive heater and the thermal controller controls the amount of thermal energy provided by the internal heater by controlling an electrical current provided to the internal heater.

10. The thermal processor of claim 9, wherein the thermal controller includes a voltage regulator to maintain an electrical voltage provided to the internal heater at a substantially constant value.

11. The thermal processor of claim 6, further comprising:
a feeder section configured to feed the imaging material to the oven; and
a position sensor configured to provide a position signal indicative of when the imaging material is at a location within the feeder section that is a known distance from the oven, wherein the thermal controller causes the internal heater to provide the amount of thermal energy prior to the imaging material contacting the at least one rotatable member based on the position signal and the processing parameters.

12. The thermal processor of claim 6, further including a reader system configured to read the processing parameters associated with the imaging material from the imaging material and/or from packaging associated with the imaging material and to provide the processing parameters to the thermal controller.

13. The thermal processor of claim 12, wherein the reader system includes a bar code scanner to read processing parameters that are in the form of a bar code corresponding to the imaging material.

14. The thermal processor of claim 12, wherein the reader system includes a radio frequency transceiver to read processing parameters that are in the form of a radio frequency tag affixed to the imaging material and/or imaging material packaging.

15. The thermal processor of claim 1, further including an oven heater configured to maintain the oven at a desired temperature, wherein the oven heater and the at least one rotatable member heat the imaging material to the desired temperature as the imaging material moves through the oven along the transport path.

16. A flat bed thermal processor for thermally developing an image in an imaging material, the processor comprising:
a first chamber including a first plurality of rollers positioned to form a first portion of a transport path and, through contact with the imaging material, configured to move the imaging material through the first chamber along the first portion of the transport path, wherein at least one of the rollers includes an internal heater; and
a second chamber configured to receive the imaging material from the first chamber and including a second plurality of rollers positioned to form a second portion of the transport path and, through contact with the imaging material, configured to move the imaging material through the second chamber along the second portion of the transport path, wherein the at least one roller of the first plurality and the at least one roller of the second plurality heat the imaging material as the imaging material moves along the transport path, and wherein the internal heaters are individually controllable to provide an amount of thermal energy based on processing parameters associated with the imaging material.

17. The thermal processor of claim 16, wherein the first chamber comprises a preheat chamber configured to heat the imaging material from an ambient temperature to a first temperature, and wherein the second chamber comprises a dwell chamber configured to the imaging material from the first temperature to a second temperature.

18. The thermal processor of claim 17, wherein the preheat chamber includes a first chamber heater configured to maintain the preheat chamber substantially at the first temperature and the dwell chamber includes a second chamber heater configured to maintain the dwell chamber substantially at the second temperature, wherein the first chamber heater and at least one heated roller of the first plurality heat the imaging material to substantially the first temperature as it moves through the preheat chamber, and wherein the second chamber heater and at least one heated roller of the second plurality heat the imaging material to the second temperature as it moves through the dwell chamber.

19. The thermal processor of claim 17, wherein the first temperature comprises a conditioning temperature and wherein the second temperature comprises a developing temperature associated with the imaging material.

20. The thermal processor of claim 16, wherein the internal heaters are individually controllable so as to provide an amount of thermal energy substantially equal to an expected amount of thermal energy expected to be absorbed by the imaging material while the imaging material is in contact with the corresponding at least one rotatable member as the imaging material moves through the oven along the transport path, and wherein the expected amount of thermal energy is based on the processing parameters associated with the imaging material.

21. The thermal processor of claim 16, wherein the internal heaters are stationary relative to the first and second chambers.

22. The thermal processor of claim 16, wherein the internal heaters are electrical resistive heaters.

23. The thermal processor of claim 16, wherein multiple rollers of the first plurality of rollers and multiple rollers of the second plurality of rollers each include an internal heater, and wherein each of the internal heats is individually controllable to provide an amount of thermal energy based on the processing parameters.

24. A thermal processor for thermally developing an image in an imaging material, the thermal processor comprising:
means for transporting the imaging material through the thermal processor, the means comprising a plurality of rotatable members positioned to form a transport path and, through contact with the imaging material, configured to move the imaging material through the thermal processor along the transport path, and
means for heating at least one of the rotatable members includes an internal heater such that the at least one rotatable member heats the imaging material as the imaging material moves along the transport path; and
means for controlling an amount of thermal energy provided by the at least one rotatable member based on processing parameters associated with the imaging material.

25. The thermal processor of claim 24, wherein the means for heating at least one of the rotatable members includes providing a heater within the at least one rotatable member.

26. The thermal processor of claim 24, wherein means for controlling an amount of thermal energy includes means for providing an amount of thermal energy to the at least one rotatable member via the heating means that is substantially equal to an amount of thermal energy expected to be absorbed from the at least one rotatable member by the imaging material as it moves along the transport path.

27. The thermal processor of claim 24, wherein the internal heater comprises an electrical resistive heater, and wherein the means for controlling an amount of thermal energy includes means for controlling an electrical current to the resistive heater.

29. A method of operating a thermal processor for thermally developing an image in an imaging material, the method comprising:
providing a plurality of rollers positioned to form a transport path and, through contact with the imaging material, configured to move the imaging material through the thermal processor along the transport path,
heating at least one of the rollers such that the at least one rollers heats the imaging material as the imaging material moves along the transport path; and
controlling an amount of thermal energy provided by the at least one roller based on processing parameters associated with the imaging material.

30. The method of claim 29, wherein controlling the thermal energy includes providing an amount of thermal energy to the at least one roller via the heating means that is substantially equal to an amount of thermal energy expected to be absorbed from the at least one rotatable member by the imaging material as it moves along the transport,path.

31. The method of claim 29, wherein heat at least one of the rollers includes providing at least one of the rollers with an internal heater.

32. The method of claim 29, wherein the internal heater comprises an electrical resistive heater, and wherein controlling the amount of thermal energy includes controlling an electrical current to the resistive heater.

33. A, thermal processor for thermally developing an image in an imaging material, the thermal processor comprising:
an oven;
an oven heater configured to maintain the oven at a desired temperature;
a first group and a second group of rollers positioned to form a transport path through the oven and, through contact with the imaging material, configured to move the imaging material along the transport path, the rollers of the first group each including an internal heater configured to provide thermal energy based on processing parameters associated with the imaging material, wherein the oven heater and the first group of rollers heat the imaging material as the imaging material moves along the transport path such that the imaging material is substantially at the desired temperature prior to contacting the second group of rollers.
